(19) United States
(12) Patent Application Publication
(10) Pub. No.: US 2014/0240884 A1
(43) Pub. Date: Aug. 28, 2014

(54) OVER CURRENT PROTECTION CIRCUIT

(71) Applicant: ADVANCED POWER ELECTRONICS CORP., Zhubei City (TW)

(72) Inventor: Cheng-Wen CHANG, Zhubei City (TW)

(73) Assignee: ADVANCED POWER ELECTRONICS CORP., Zhubei City (TW)

(21) Appl. No.: 13/775,387

(22) Filed: Feb. 25, 2013

(51) Int. Cl. H02H 9/02

(52) U.S. Cl. CPC H02H 9/025
USPC 361/93.1

(57) ABSTRACT

The over current protection circuit is coupled to a current path between an output end of a switch and a load. The over current protection circuit includes a first over current detection unit, a second over current detection unit and a control unit. The first over current detection unit is disposed between the current path and a first voltage, and generates a first control signal according to a current in the current path. The second over current detection unit is disposed between the current path and a second voltage, and generates a second control signal according to a current in the current path. The control unit is coupled with the first over current detection unit and the second over current detection unit, and controls the switch according to the first control signal or the second control signal to reduce the current in the current path.

### TECHNICAL FIELD

The present disclosure relates to a protection circuit, and more particularly to an over current protection circuit.

### BACKGROUND

An over current state, which usually is encountered when an electronic apparatus is started or a load circuit is varied, not only affects the operation of the electronic device but also may cause damage to the entire system. Therefore, an over current protection circuit is needed in an electronic apparatus to limit the current and thereby prevent an excessive amount of current from damaging the entire system. Moreover, limiting the current may also help reduce power consumption. Typically, a current detection unit is used to detect the current at the input end of a switch, and a control signal is generated according to the detecting result. The control signal may control the switch to control the input current to the load.

FIG. 1 is a schematic block diagram of a typical over current protection circuit. The over current protection circuit 100 is disposed between a power supply input end Vin and a load 101 to control a switch, which is an N-type transistor 104. The over current protection current 100 includes a current detection unit 103 and a control unit 106. The current I in the current path 105 is varied according to the load 101. When the current detection unit 103 detects that the current I is less than a particular value, the control unit 106 controls the N-type transistor 104 to an on state. That is, a high-level voltage is applied to the gate electrode of the N-type transistor 104. The current flowing through the N-type transistor 104 is controlled by the voltage difference between the gate electrode and the source electrode. On the other hand, when the current detection unit 103 detects an over current state in the current path 105, the control unit 106 pulls down the voltage applied to the gate electrode of the N-type transistor 104 to thereby reduce the voltage difference between the gate electrode and the source electrode, ultimately limiting the current flowing through the N-type transistor 104.

### SUMMARY

The present invention discloses an over current protection circuit. The over current protection circuit is coupled to a current path between an output end of a switch and a load. The over current protection current includes a first over current detection unit, a second over current detection unit and a control unit. The first over current detection unit couples between a current path and a first voltage. The first over current detection unit generates a first control signal according to a current in the current path. The second over current detection unit couples between the current path and a second voltage. The second over current detection unit generates a second control signal according to a current in the current path. The control unit couples with the first over current detection unit and the second over current detection unit. The control unit controls the switch according to the first control signal or the second control signal to reduce the current in the current path.

In an embodiment, the switch is a transistor. The drain electrode of the transistor couples with an input end of a power supply. The source electrode of the transistor couples with the current path.

In an embodiment, the control unit comprises a gate voltage supply circuit, a first N-type transistor and a second N-type transistor. The drain electrode of the first N-type transistor couples with the gate electrode of the transistor. The gate electrode of the first N-type transistor receives the first control signal. The drain electrode of the second N-type transistor couples with the gate electrode of the transistor. The gate electrode of the second N-type transistor receives the second control signal.

In an embodiment, the first over current detection unit comprises a first amplifier, a third N-type transistor, a first resistor and a second resistor. The first amplifier has a positive end, a negative end and an output end. The positive end and the negative end of the first amplifier sequentially couple to the current path in accordance with the current direction. The gate electrode of the third N-type transistor couples to the output end of the first amplifier. The drain electrode of the third N-type transistor couples to the positive end of the first amplifier. The positive end of the first amplifier is coupled to the current path through the first resistor. The source electrode of the third N-type transistor couples to the first voltage through the second resistor. When a current flows through the second resistor, the first control signal is generated.

In an embodiment, the second over current detection unit comprises a second amplifier, a first P-type transistor, a second P-type transistor, a third resistor and a fourth resistor. The second amplifier has a positive end, a negative end and an output end. The negative end and the positive end of the second amplifier sequentially couple to the current path in accordance with the current direction. The gate electrode of the first P-type transistor couples to the output end of the second amplifier. The drain electrode of the first P-type transistor couples to the positive end of the second amplifier. The source electrode of the first P-type transistor couples to the second voltage. The first P-type transistor and the second P-type transistor form a current mirror. The gate electrode of the second P-type transistor couples to the output end of the second amplifier. The source electrode of the second P-type transistor couples to the second voltage. The positive end of the second amplifier is coupled to the current path through the third resistor. The drain electrode of the second P-type transistor couples to the fourth resistor. When a current flows through the fourth resistor, the second control signal is generated.

In an embodiment, when there is an over current state in the current path, a first current is generated in the source electrode of the third N-type transistor according to the level of the over current in the current path. When the first current flows through the second resistor, the first control signal is generated to turn on the first N-type transistor to change the voltage applied to the gate electrode of the switch to reduce the current in the current path.

In an embodiment, when there is an over current state in the current path, a second current is generated in the drain electrode of the second P-type transistor according to the level of the over current in the current path. When the second current flows through the fourth resistor, the second control signal is generated to turn on the second N-type transistor to change the voltage applied to the gate electrode of the switch to reduce the current in the current path.

Accordingly, a first over current detection unit and a second over current detection unit are coupled to a current path that is connected to a load to provide over current protection. By setting the operation voltage of the first over current detection unit and the second over current detection unit, the start timing of the two over current detection units and the scope of protection voltage can be determined to provide full over current protection.

### BRIEF DESCRIPTION OF THE DRAWINGS

In order to make the foregoing as well as other aspects, features, advantages, and embodiments of the present disclosure more apparent, the accompanying drawings are described as follows:

FIG. 1 is a schematic block diagram of a typical over current protection circuit.

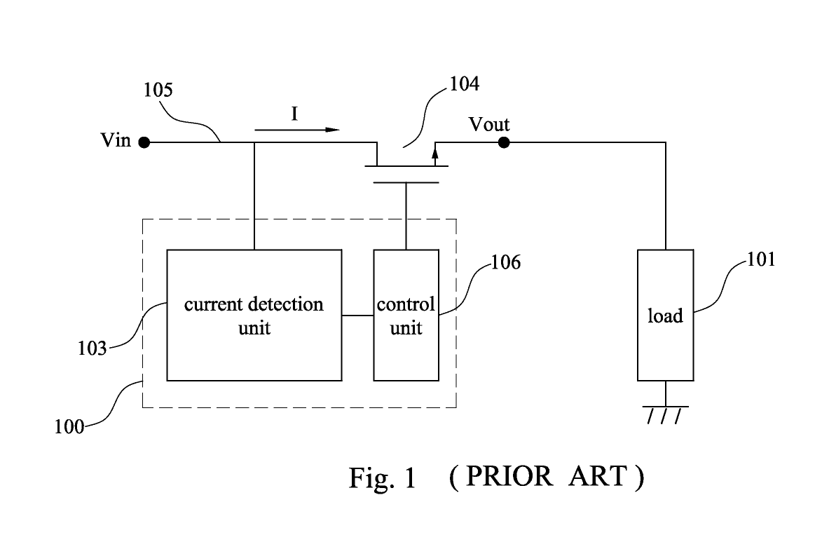

FIG. 2 is a schematic diagram of an over current protection circuit in accordance with an embodiment of the present invention.

FIG. 3 is a circuit diagram of an over current protection circuit in accordance with an embodiment of the present invention.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

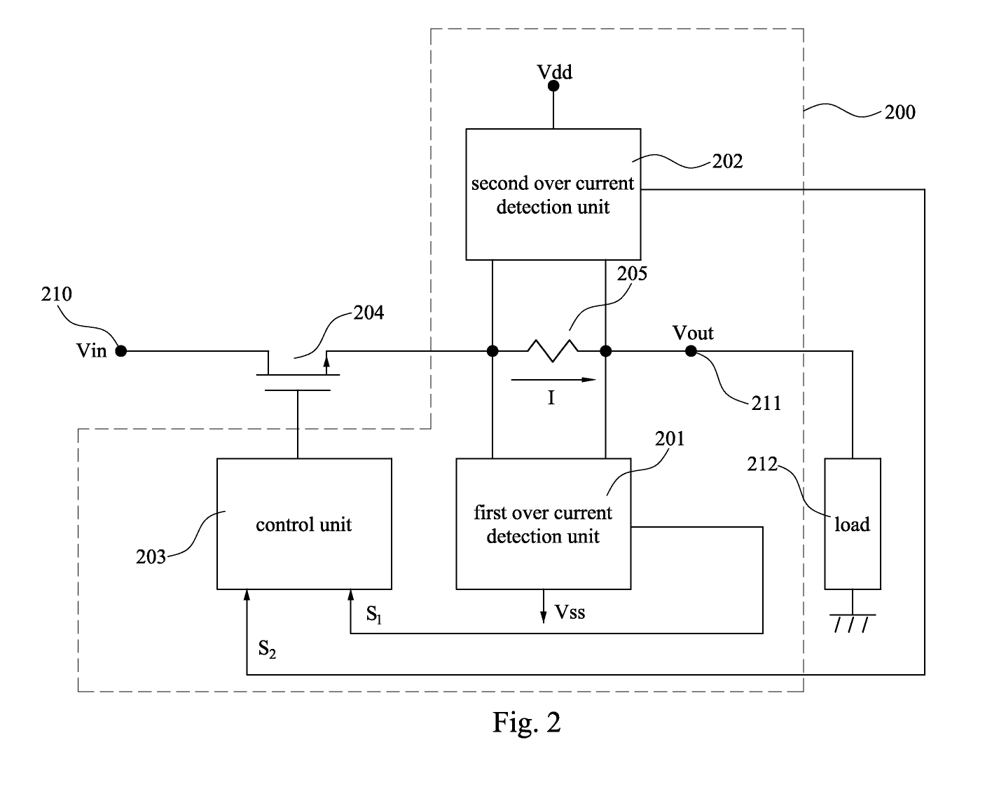

FIG. 2 is a schematic diagram of an over current protection circuit in accordance with an embodiment of the present invention. The over current protection circuit 200 is coupled to an output end of a switch 204 and to a load 212. The over current protection current 200 includes a first over current detection unit 201, a second over current detection unit 202 and a control unit 203. In the following embodiment, the switch 204 is an N-type transistor. However, in other embodiments, the switch 204 can be a P-type transistor. The drain electrode of the switch 204 is connected to an input end 210 of a power supply to receive an input voltage Vin. The source electrode of the switch 204 is connected to a current path 205 to generate a voltage Vout at an output end 211 to supply to the load 212. The first over current detection unit 201 couples with the current path 205 to generate a first control signal S1 according to a current flowing in the current path 205. The second over current detection unit 202 also couples with the current path 205 to generate a second control signal S2 according to a current flowing in the current path 205. The control unit 203 couples with the first over current detection unit 201 and the second over current detection unit 202. The control unit 203 may generate a control signal according to the first control signal S1 and the second control signal S2, and output the control signal to the gate electrode of the switch 204. The control signal may switch the switch 204 to reduce the current in the current path 205.

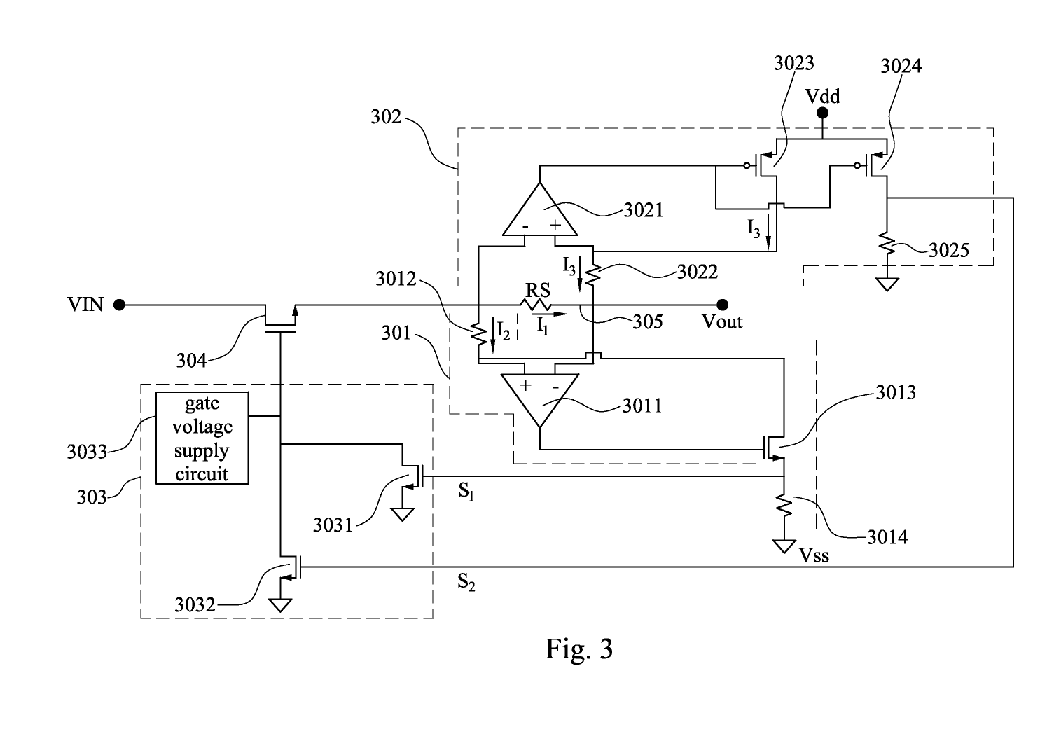

FIG. 3 is a circuit diagram of an over current protection circuit in accordance with an embodiment of the present invention. In an embodiment, the control unit 303 further comprises a gate voltage supply circuit 3033, a first N-type transistor 3031 and a second N-type transistor 3032. The drain electrode of the first N-type transistor 3031 couples with the gate electrode of the switch 304. The gate electrode of the first N-type transistor 3031 receives the first control signal S1. The drain electrode of the second N-type transistor 3032 couples with the gate electrode of the switch 304. The gate electrode of the second N-type transistor 3032 receives the second control signal S2. When there is no over current state in the current path 305, the gate voltage supply circuit 3033 provides a voltage to keep the switch 304 on. In contrast, when there is an over current state in the current path 305, the first control signal S1 generated by the first over current detection unit 301, or the second control signal S2 generated by the second over current detection unit 302 turns on the first N-type transistor 3031 or the second N-type transistor 3032 to switch the switch 304 to reduce the current in the current path 305, thereby realizing over current protection.

In an embodiment, the first over current detection unit 301 further comprises a first amplifier 3011, a first resistor 3012, a third N-type transistor 3013 and a second resistor 3014. The first amplifier 3011, the first resistor 3012, the third N-type transistor 3013 and the second resistor 3014 form a negative feedback circuit structure. The first over current detection unit 301 uses the negative feedback circuit structure to force the positive end and the negative end of the first amplifier 3011 to be in a same electric potential. The output end of the first amplifier 3011 couples to the gate electrode of the third N-type transistor 3013. The positive end and the negative end of the first amplifier 3011 sequentially couple to the current path 305 in accordance with the current I1 direction. The source electrode of the third N-type transistor 3013 couples to a voltage Vss through the resistor 3014. The drain electrode of the third N-type transistor 3013 couples to the positive end of the first amplifier 3011. The positive end of the first amplifier 3011 is coupled to the current path 305 through the resistor 3012.

In an embodiment, the current path 305 has a path resistor Rs. The current that flows through the path resistor Rs is current I1. The current that flows through the first resistor 3012 is current I2. When there is an over current state in the current path 305, the current that flows through the path resistor Rs, namely, current I1, is increased. Because of the negative feedback circuit structure, the current that flows through the first resistor 3012, namely, current I2, is also increased. On the other hand, because the positive end and the negative end of the first amplifier 3011 are sequentially coupled to the current path 305 in accordance with the current I1 direction, the output end of the first amplifier 3011 outputs a high-level electric potential to turn on the third N-type transistor 3013. The increased current I2 flows through the second resistor 3014 through the turned on third N-type transistor 3013 to generate a voltage, namely, the first control signal S1. When the generated voltage is larger than the threshold voltage of the first N-type transistor 3031 in the control unit 303, the first N-type transistor 3031 is turned on to pull down the voltage applied to the gate electrode of the switch 304, so that the current in the current path 305 is reduced. Therefore, an over current state is prevented. When the voltage applied to the gate electrode of the switch 304 is pulled down to a predetermined value, the voltage Vout is also pulled down to a predetermined voltage, such that the second over current detection unit 302 is activated.

The second over current detection unit 302 further comprises a second amplifier 3021, a third resistor 3022, a fourth resistor 3025, a first P-type transistor 3023 and a second P-type transistor 3024. The first P-type transistor 3023 and the second P-type transistor 3024 form a current mirror. The second amplifier 3021, the third resistor 3022, the current mirror and the fourth resistor 3025 form a negative feedback circuit structure. The second over current detection unit 302 uses the negative feedback circuit structure to force the positive end and the negative end of the second amplifier 3021 to be in a same electric potential. The second amplifier 3021 has a positive end, a negative end and an output end. The output end of the second amplifier 3021 couples to the gate electrode of the first P-type transistor 3023 and the gate electrode of the second P-type transistor 3024. The negative end and the positive end of the second amplifier 3021 sequentially couple to the current path 305 in accordance with the current I1 direction. The drain electrode of the first P-type transistor 3023 couples to the positive end of the second amplifier 3021. The source electrode of the first P-type transistor 3023 couples to the voltage Vdd. The source electrode of the second P-type transistor 3024 couples to the voltage Vdd. The positive end of the second amplifier 3021 is coupled to the current path 305 through the third resistor 3022. The drain electrode of the second P-type transistor 3024 couples to the fourth resistor 3025. When a current flows through the fourth resistor 3025, the second control signal S2 is generated.

In an embodiment, the current path 305 has a path resistor Rs. The current that flows through the path resistor Rs is current I1. The current that flows through the third resistor 3022 is current I3. When there is an over current state in the current path 305, the current that flows through the path resistor Rs, namely, current I1, is increased. Because of the negative feedback circuit structure, the current that flows through the third resistor 3022, namely, current I3, is also increased. On the other hand, because the negative end and the positive end of the second amplifier 3021 are sequentially coupled to the current path 305 in accordance with the current I1 direction, the output end of the second amplifier 3021 outputs a low-level electric potential to turn on the first P-type transistor 3023 and the second P-type transistor 3024. The increased current I3 also induces a current proportional to the current in the drain electrode of the second P-type transistor 3024. The induced current flows through the fourth resistor 3025 to generate a voltage, namely, the second control signal S2. When the generated voltage is larger than the threshold voltage of the second N-type transistor 3032 in the control unit 303, the second N-type transistor 3032 is turned on to pull down the voltage applied to the gate electrode of the switch 304, so that the current in the current path 305 is reduced. Therefore, an over current state is prevented.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. An over current protection circuit, comprising:
a switch having a first end and a second end, wherein the first end receives an input voltage from a power supply to generate an output voltage in the second end;
a current path disposed between the second end and a load, wherein the output voltage is provided to a load through the current path;
a first over current detection unit coupled between the current path and a first voltage, wherein the first over current detection unit generates a first control signal according to a current in the current path;
a second over current detection unit coupled between the current path and a second voltage, wherein the second over current detection unit generates a second control signal according to a current in the current path; and
a control unit coupled with the first over current detection unit and the second over current detection unit, wherein the control unit controls the switch according to the first control signal or the second control signal to reduce a current in the current path.

2. The over current protection circuit of claim 1, wherein the switch is a transistor, the first end is the drain electrode of the transistor to receive the input voltage, and the source electrode of the transistor to couple with the current path.

3. The over current protection circuit of claim 2, wherein the control unit comprises:
a gate voltage supply circuit coupled with the gate electrode of the transistor;
a first N-type transistor, wherein the drain electrode of the first N-type transistor couples with the gate electrode of the transistor, and the gate electrode of the first N-type transistor receives the first control signal; and
a second N-type transistor, wherein the drain electrode of the second N-type transistor couples with the gate electrode of the transistor, and the gate electrode of the second N-type transistor receives the second control signal.

4. The over current protection circuit of claim 3, wherein the first over current detection unit comprises:
a first amplifier with a positive end, a negative end and an output end, wherein the positive end and the negative end of the first amplifier sequentially are coupled to the current path in accordance with a current direction in the current path;
a third N-type transistor, wherein the gate electrode of the third N-type transistor couples to the output end of the first amplifier, and the drain electrode of the third N-type transistor couples to the positive end of the first amplifier;
a first resistor, wherein the positive end of the first amplifier is coupled to the current path through the first resistor; and
a second resistor, wherein the source electrode of the third N-type transistor couples to the first voltage through the second resistor, and when a current flows through the second resistor, the first control signal is generated.

5. The over current protection circuit of claim 4, wherein when there is an over current state in the current path, a first current is generated in the source electrode of the third N-type transistor according to the level of the current in the current path.

6. The over current protection circuit of claim 5, wherein when the first current flows through the second resistor, the first control signal is generated to turn on the first N-type transistor to change the voltage applied to the gate electrode of the switch to reduce the over current in the current path.

7. The over current protection circuit of claim 3, wherein the second over current detection unit comprises:
a second amplifier with a positive end, a negative end and an output end, wherein the negative end and the positive end of the second amplifier are sequentially coupled to the current path in accordance with a current direction in the current path;
a first P-type transistor, wherein the gate electrode of the first P-type transistor couples to the output end of the second amplifier, the drain electrode of the first P-type transistor couples to the positive end of the second amplifier, and the source electrode of the first P-type transistor couples to the second voltage;
a second P-type transistor, wherein the first P-type transistor and the second P-type transistor form a current mirror structure, the gate electrode of the second P-type transistor couples to the output end of the second amplifier, and the source electrode of the second P-type transistor couples to the second voltage;
a third resistor, wherein the positive end of the second amplifier is coupled to the current path through the third resistor; and
a fourth resistor, wherein the drain electrode of the second P-type transistor couples to the fourth resistor, and when a current flows through the fourth resistor, the second control signal is generated.

8. The over current protection circuit of claim 7, wherein when there is an over current state in the current path, a second current is generated in the drain electrode of the second P-type transistor according to the level of the over current in the current path.

9. The over current protection circuit of claim 8, wherein when the second current flows through the fourth resistor, the second control signal is generated to turn on the second N-type transistor to change the voltage applied to the gate electrode of the switch to reduce the over current in the current path.
